(19) United States
(12) Patent Application Publication
(10) Pub. No.: US 2008/0301980 A1
(43) Pub. Date: Dec. 11, 2008

(54) APPARATUS AND METHOD FOR MATERIAL HANDLING ON AN IRREGULAR SURFACE

(76) Inventor: JESSE E. HILL, III, Canton, CT (US)

Correspondence Address: ROBERT S. SMITH, 1131-0 TOLLAND TURNPIKE, SUITE 306, MANCHESTER, CT, 06040, US

(21) Appl. No.: 11/758,625

(22) Filed: Jun. 5, 2007

(51) Int. Cl. A01B 1/02

(52) U.S. Cl. 37/379; 37/446

(57) ABSTRACT

Apparatus for moving associated material which includes a mounting and a blade carried on the mounting, the blade having an edge for engaging a quantity of material to be moved, the edge having a bead extending along the edge, the bead having a cross-section that has a curvilinear contour whereby the blade will be deflected away from interfering obstacles within the associated material. In some embodiments the apparatus may be a shovel. In some of these embodiments, the bead has a circular cross-section. Some embodiments have the circular cross-section and others have a curvilinear cross-section. The invention also includes the method for moving material which includes providing a mounting and providing a blade carried on the mounting that has an edge for engaging a quantity of material to be moved, providing an bead extending along the edge that has a cross-section that has a curvilinear contour whereby the blade will be deflected away from interfering obstacles within the associated material.

### FIELD OF THE INVENTION

The invention has application to apparatus for material handling and particularly the leading edge of any material moving or handling device. Such apparatus include, but are not limited to, shovels. One of many examples of apparatus to which the present invention has application is a snow shovel for moving snow from a deck having upstanding nails protruding from the upper surface or moving snow from a roof having shingles where the outer faces of the respective shingles are not coplanar. Other examples, include snow plows as well as snow pushers or scoops such as that commonly used in ski areas, hotel entry ways etc. The invention also includes a method for material handling on an irregular surface.

### BACKGROUND OF THE INVENTION

The initial design of the present invention was inspired by difficulty encountered when shoveling snow off a wooden deck which had a large number of nail and screw heads that were not seated flush with respect to the top surface of the deck. The flat leading edge of a traditional plastic snow shovel/pusher collided with the nail or screw heads and work was difficult.

People have cleared materials from surfaces and moved materials from one location to another since ancient times. The necessity continues today. Many devices have been designed to clear assorted materials which rest on a variety of surfaces. Snow shovels, street plows, other industrial plows, farm equipment, and earth moving equipment are but a few examples. These devices tend to be similarly designed with a flat or acutely angled leading edge.

The traditional flat or acutely angled snow shovel leading edge helps the device penetrate the material to be moved, and helps to clear the material as completely as possible from the surface on which it rests. However many devices so designed share similar difficulties.

When a device with a flat or acutely angled leading edge collides with an object protruding upward from the surface on which the material rests, the forward progress of the device can be stopped abruptly. A nail or screw that is not completely driven flush to the deck surface will stop a snow shovel's movement. Apparatus with such leading edges, when used to clear a rough surface such as a frozen gravel driveway or pathway, each bit of gravel frozen to the surface is an obstacle that can deter progress. A non-frozen gravel or fine stone (pea stone) driveway or walkway, or a bark chip pathway are examples of soft surfaces and can also be difficult to clear of snow or other unwanted debris using a flat or acutely angled leading edge device because some of the gravel, stone, or chips will be lifted up and thrown or plowed away with the material being cleared.

Striking a loose impediment such as a stone or loose ice chunk with a flat or acutely angled leading edge device while clearing any surface, can make forward progress erratic and increases the chance for gouging. Paved streets with manhole covers and other irregularities traumatize the leading edge of street plows. Agricultural and industrial surfaces may have similar obstruction, texture, or contour problems.

It is interesting that when a flat or acutely angled leading edge is drawn backward across such an obstruction or uneven surface, the backward motion is not impeded. A man powered device such as a snow shovel with a flat or acutely angled leading can be very frustrating to use. If a protruding nail or screw is struck when shoveling or pushing snow off a deck, the operator must absorb the shock of the collision. Injury may occur to the hands, arms, neck, back or legs. An engine powered device such as a street plow with a flat or acutely angled leading edge can be damaged when striking the lip of a manhole cover, a wide seam in the road, or a seam adjoining the road to a bridge. When such obstructions are encountered, the plow blade must sometimes be raised to avoid damage to the plow equipment. Elaborate spring loaded systems are employed to absorb the shock of these collisions. Plowing a paved surface with cracks, or plowing an unpaved stone or gravel surface often present obstructions that increase wear and tear of the equipment. The surface can be gouged. Some of the structure of the surface itself may be removed or discarded.

To date, some devices have been patented that attempt to improve the ease with which shoveling may proceed over an uneven surface. These devices rely on a design feature of the under or back surface of the shovel so that the under or back surface serves as a fulcrum to raise the leading edge.

When an obstruction is anticipated, or after it is struck, the handle must be pushed down. This action raises the leading edge and forward progress may continue. These designs require the handle of the shovel to be pressed down/lowered.

U.S. Pat. No. 3,078,604 employs a pair of brackets affixed to the back of the shovel. Patent Application #2005018542A1 employs a wedge or other shaped protrusion placed behind the leading edge and extending along the entire length of the leading edge. Both designs incorporate a flat or acutely angled leading edge. If the handle is properly lowered (the inventors of #2005018542A1 suggest pushing down ten inches), the leading edge is raised and progress beyond the obstruction is allowed. These designs require action be taken by the operator. If the maneuver is not properly executed, the flat or acutely angled leading edge will impact the obstruction at full working speed. Both these designs site misaligned sections of a concrete sidewalk, or cracks in a paved surface as the types of obstructions to be overcome.

### SUMMARY OF THE INVENTION

It is an object of the present invention to provide a method and apparatus that will increase the ease with which the device scrapes, moves, or removes material from the surface on which the material rests.

Another object of the present invention is to provide apparatus that will, by means of a simple modification to the leading edge of any device intended for such work, will greatly improve the performance of the device.

Still another object of the invention is to provide an apparatus and method that will pass over obstructions on the surface from which material, such a snow, is deposited.

A further object of the invention is to provide apparatus that will avoid scoping of materials, such as the sod and soil under accumulated snow, that are not part of the material that is intended to be moved.

Yet another object of the present invention is to provide an apparatus and method that will utilize a rounded or otherwise smoothed leading edge requires no special action by the user and which is inherently a “passive” system. More particularly, it is an object of the present invention to provide a method and apparatus in which the height of the handle above the surface being cleared is not critical and the handle need not be actively pushed down in order to raise the leading edge. The leading edge is not stopped when an appropriate obstruction is encountered. The shape of the edge simply allows it to glide over the obstruction. No abrupt shock is experienced; work proceeds with no additional effort or attention by the user.

A still further object of the invention is to eliminate the abrupt jolt the individual operating the device experiences when the leading edge collides with an obstruction. Forward progress is smooth and is not interrupted over rough or uneven surface. Material can be removed from a loose or soft surface without removing as much of the loose or soft surface itself. Loose impediments will not deflect the intended direction of motion or increase the chance for gouging.

Another object of the invention is to reduce the effort required to complete the work and to reduce the chance for injury as well as to reduce the chance that the surface on which the material rests will be disturbed or marred.

Another object of the invention is to increase the durability of the leading edge of the blade.

It is also an object of the present invention to provide a method and apparatus that has less of a tendency for forward or backward motion of a device, such as a shovel, to be stopped by high density portion of the material being moved or objects that project upwardly.

It has now been found that these and other objects of the present invention may be attained in apparatus for moving associated material which includes a mounting and a blade carried on the mounting, the blade having an edge for engaging a quantity of material to be moved, the edge having a bead extending along the edge, the bead having a cross-section that has a curvilinear contour whereby the blade will be deflected away from interfering obstacles within the associated material.

In various embodiments apparatus may be a shovel. In some of these embodiments, the bead has a circular cross-section. Some embodiments have the circular cross-section disposed substantially centered with respect to the blade, disposed in an offset relationship to the blade whereby a major part of the circular cross-section is proximate to a side of the blade that contacts the associated material or disposed in an offset relationship to the blade whereby a major part of the circular cross-section is proximate to a side of the blade that does not contact the associated material.

Other embodiments may have a bead that has a curvilinear cross-section. Some embodiments have the curvilinear cross-section disposed substantially centered with respect to the blade, disposed in an offset relationship to the blade whereby a major part of the curvilinear cross-section is proximate to a side of the blade that contacts the associated material or disposed in an offset relationship to the blade whereby a major part of the curvilinear cross-section is proximate to a side of the blade that does not contact the associated material. Other embodiments have the bead formed by an axial section of tubing having an axial slit and secured to the edge.

The invention also includes the method for moving material which includes providing a mounting and providing a blade carried on the mounting that has an edge for engaging a quantity of material to be moved, providing a bead extending along the edge that has a cross-section that has a curvilinear contour whereby the blade will be deflected away from interfering obstacles within the associated material.

Some forms of the method have steps of providing a mounting and providing a blade are part of the method of providing a shovel having a bead on the leading edge of the blade. The method may include offsetting the bead with respect to the blade. The offsetting may offset with the bead respect to the blade so that most of the bead is on the side of the blade that contacts the material being moved or may offset the bead with respect to the blade so that most of the bead is on the side of the blade that does not contact the material being moved.

### BRIEF DESCRIPTION OF THE DRAWING

The invention will be better understood by reference to the accompanying drawing in which:

FIG. 1 is a schematic side elevation view of a prior art shovel such as a snow shovel with traditional flat or acutely angled leading edge and which suffers from the disadvantages described above.

FIG. 2 is a schematic side elevation view of another form of the blade in accordance with the present invention having a generally circular cross-section bead on the leading edge of the blade and centered with respect to the blade.

FIG. 3 is a schematic side elevation view of another form of the blade in accordance with the present invention having a generally circular cross-section bead 26 on the leading edge of the blade 24 of the shovel that is offset toward the front face of the blade.

FIG. 4 is a schematic side elevation view of another form of the blade in accordance with the present invention having a generally circular cross-section bead 30 on the leading edge of the blade 28 of the shovel and offset toward the back face of the blade.

FIG. 5 is a schematic side elevation view of another form of the blade in accordance with the present invention having a generally teardrop shaped cross-section bead 34 on the leading edge of the blade 32 of the shovel and centered with respect to the blade.

FIG. 6 is a schematic side elevation view of another form of the blade in accordance with the present invention having a generally curvilinear cross-section bead 38 on the leading edge of the blade 36 of the shovel and offset toward the front face of the blade as opposed to other embodiments that have the bead not offset or offset toward the back.

FIG. 7 is a schematic side elevation view of another form of the blade in accordance with the present invention having a generally curvilinear cross-section bead on the leading edge of the blade and the curvilinear section includes a portion which is linear.

### DESCRIPTION OF THE PREFERRED EMBODIMENTS

The present invention includes embodiments focused on the leading edge of any material moving or handling device. If a material moving device is designed with a rounded or otherwise smoothed leading edge, all the difficulties discussed above are greatly reduced. Forward movement is significantly less impeded when an object or an uneven surface is encountered. Backward motion is not affected.

The clearing ability of a device with a rounded or smoothed leading edge is slightly reduced, but the reduction in clearing is worth the gain in efficiency. Work is continuous, and progress is smooth. The chance for injury is less. Snow may not be cleared quite as completely with such a device, but if the deck has protruding screws or nails, the job is done with far less difficulty.

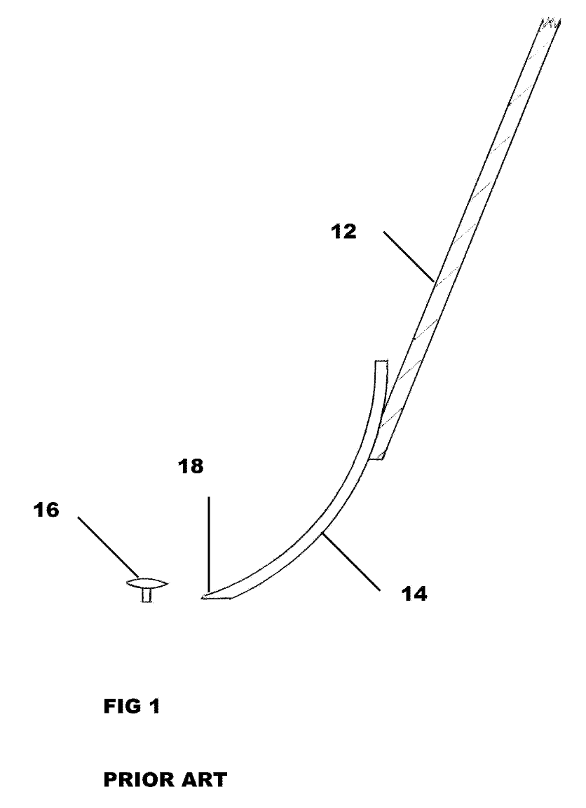

When using a device with a traditional flat or acutely angled leading edge to clear material from a deck or planked surface, striking a nail or screw head that protrudes above the surface will abruptly impede forward progress. This is shown in FIG. 1 of the drawings. The same is true when pushing at 90 degrees (right angles) to the boards that make up a deck, or across a brick surface, or an area covered with paving stones. Pushing forward on an uneven surface such as gravel can be difficult. The flat or acutely angled leading edge of the traditional material moving device is grabbed by such obstructions and wants to dig in to the deck, gravel, or paved surface. When using a device that incorporates a “fulcrum”, holding the handle down continuously to avoid any of these obstructions would probably work, but the user of the shovel is required to actively maintain the handle at a certain height above the surface in order to keep the leading edge properly elevated.

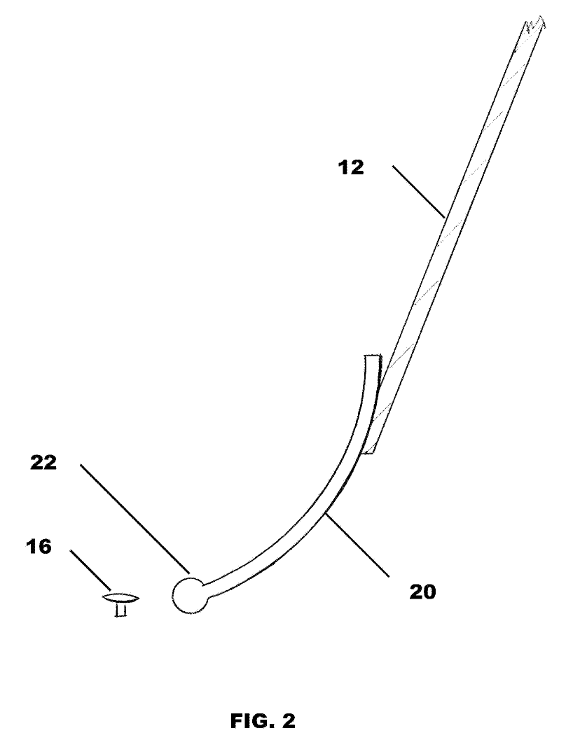

In one embodiment of the present invention, the leading edge of a traditional plastic snow shovel/pusher is constructed such as that shown in FIG. 2. This embodiment has a generally circular cross-section bead 22 on the leading edge on a blade 20 that is supported on a handle 12. An initial prototype used flexible, half inch I.D., ABS tubing that was slit lengthwise, and placed along the leading edge of the shovel blade 20. The tubing was affixed with one pop rivet at each lateral extreme of the blade 22. The modified shovel cleared snow from the deck, gliding practically without notice over the protruding nail and screw heads. This prototype will serve to illustrate several points pertinent to this invention. Most of its features are illustrated in FIG. 2. This construction makes it easier for the shovel to glide over objects which project upward from the surface, over seams in the surface, and over uneven, irregular or soft surfaces.

Although the description herein illustrates the concept primarily by reference to snow shovels, it will be understood that it also has application to all hand or otherwise manpower operated snow shovels or plows; engine driven snow plows; farm equipment utilized to move materials; earth moving devices; garden equipment; surface leveling devices such as those used to smooth concrete; and the leading edge of the material intake manifold, such as on the bottom edge of a snow blower or thrower. A huge number of devices may benefit.

Ordinarily, the curvilinear cross section of the leading edge of the tool will extend across the entire length of the leading edge of the device. For some applications, the curvilinear cross-section of the leading edge may extend over only axial portions of the leading edge.

Preferred embodiments of the present invention have a leading edge curvilinear cross-section bead that extends from the back surface of the blade, continue under the leading edge of the device, and continue to the front surface of the blade. Other embodiments may have the blade disposed and an asymptotic relationship to a curvilinear cross-section bead. This is distinct from the devices discussed above that incorporate a wedge or other shaped protrusion along the back edge only (U.S. Pat. No. 3,078,604 and Patent Application 2005018542A1). Those protrusions serve as a fulcrum to allow the leading edge to be raised.

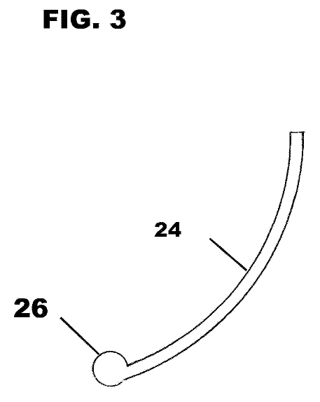

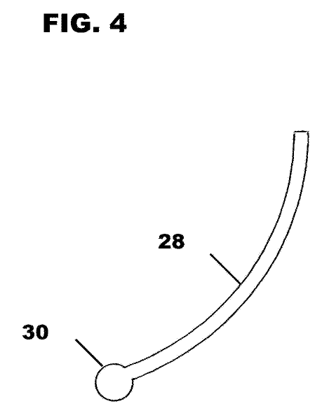

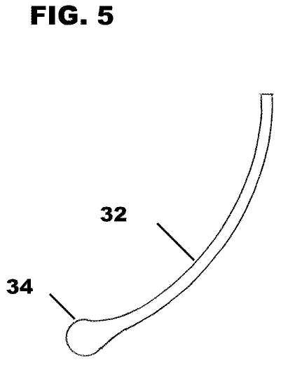

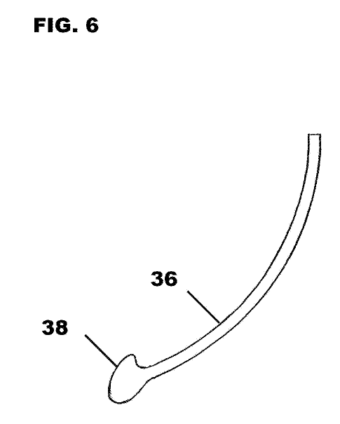

Preferably the contours of the bead should blend or merge smoothly with the back and front surfaces of the device. To increase strength at the points of transition, it may be beneficial to provide gussets or other extra material. The cross section of the leading edge design is vital. A wide variety of shapes may prove useful in specific applications. The cross section of the bead must be a smooth shape. The cross section may be round as in FIG. 2. The ABS tubing used on the prototype device has a substantially round cross section (although when secured to the edge the contour may vary). The bead may be offset with respect to the edge of the blade as shown in FIGS. 3 and 4. The bead may be teardrop shaped as shown in FIG. 5 or some other curvilinear shape as shown in FIG. 6. In some embodiments the cross section may be any portion of the arc of a circle, or any portion of an ellipse.

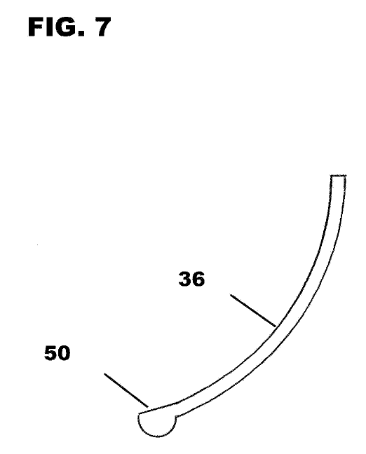

FIG. 7 is a schematic side elevation view of another form of the blade 36 in accordance with the present invention having a generally curvilinear cross-section bead 50 on the leading edge of the blade and the curvilinear section includes a portion which is linear.

In some embodiments the leading edge of the shovel or other implement may be made of the same material as the rest of the blade or alternatively may be made of a material that is different than the blade. Some embodiments may be manufactured or installed as a permanent component/feature while others may make the leading edge construction removable. The design may be a feature at the time of manufacture of a device, or it may be an add-on or after market component for that device.

The design may be a convertible component of a device. It may be one of two or more interchangeable leading edges for a device. For example, a snow shovel may be designed with a removable leading edge. A traditional flat or acutely angled edge could be interchanged with the smooth design leading edge.

The design may be injected molded or otherwise molded as would be appropriate for a plastic shovel. It may be cast, pressed or milled as would be appropriate for a metal shovel. It may be welded as may be appropriate for an engine powered plow, farm or earth moving equipment. It may be attached by rivet, by screw, by any type fastener, or by adhesive.

A device with this design will have a somewhat thicker leading edge. This will increase the longevity of the implement. It will also reduce the tendency for excessive wear at the lateral extremes of the leading edge as is common for many shovels and plows of current design.

The curvilinear leading edge in the apparatus and method of the present invention has less of a tendency for forward or backward motion of the apparatus, such as a shovel, to be stopped by objects that project upward, or over rough or uneven surfaces. Such a material handling device has less of a tendency to dig in or gouge a surface consisting of loose or soft material and is less affected by loose impediments on the surface. While the present design slightly reduces the ability of the leading edge to penetrate materials or clear the last trace of material from a surface, but in nearly all situations the reduction is insignificant. The term “curvilinear” as used herein will be understood to include contours that are primarily curved although portions thereof may be linear.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. Apparatus for moving associated material which comprises:
a mounting and
a blade carried on said mounting, said blade having an edge for engaging a quantity of material to be moved, said edge having a bead extending along said edge, said bead having a cross-section that has a curvilinear contour whereby said blade will be deflected away from interfering obstacles within the associated material.

2. The apparatus as described in claim 1 wherein said apparatus is a shovel.

3. The apparatus as described in claim 2 wherein said mounting is an elongated handle and said bead has a circular cross-section.

4. The apparatus as described in claim 2 wherein said mounting is an elongated handle and said bead has a circular cross-section that is disposed substantially centered with respect to said blade.

5. The apparatus as described in claim 2 wherein said mounting is an elongated handle and said bead has a circular cross-section that is disposed in an offset relationship to said blade whereby a major part of said circular cross-section is proximate to a side of said blade that contacts the associated material.

6. The apparatus as described in claim 2 wherein said mounting is an elongated handle and said bead has a circular cross-section that is disposed in an offset relationship to said blade whereby a major part of said circular cross-section is proximate to a side of said blade that does not contact the associated material.

7. The apparatus as described in claim 2 wherein said mounting is an elongated handle and said bead has a curvilinear cross-section that is disposed in an offset relationship to said blade whereby a major part of said curvilinear cross-section is proximate to a side of said blade that contacts the associated material.

8. The apparatus as described in claim 2 wherein said mounting is an elongated handle and said bead has a curvilinear cross-section that is disposed in an offset relationship to said blade whereby a major part of said curvilinear cross-section is proximate to a side of said blade that does not contact the associated material.

9. The apparatus as described in claim 2 wherein said mounting is an elongated handle and said bead is formed by an axial section of tubing having an axial slit and secured to said edge.

10. A method for moving material which comprises:
providing a mounting and
providing a blade carried on the mounting that has an edge for engaging a quantity of material to be moved, providing a bead extending along the edge that has a cross-section that has a curvilinear contour whereby said blade will be deflected away from interfering obstacles within the associated material.

11. The method as described in claim 10 wherein the steps of providing a mounting and the step of providing a blade are part of the method of providing a shovel having a bead on the leading edge of the blade that is substantially centered with respect to the blade.

12. The method as described in claim 10 wherein the steps of providing a mounting and the step of providing a blade are part of the method of providing a shovel having a bead on the leading edge of the blade that is offset with respect to the blade.

13. The method as described in claim 10 wherein the steps of providing a mounting and the step of providing a blade are part of the method of providing a shovel having a bead on the leading edge of the blade that is offset with respect to the blade so that most of the bead is on the side of the blade that contacts the material being moved.

14. The method as described in claim 10 wherein the steps of providing a mounting and the step of providing a blade are part of the method of providing a shovel having a bead on the leading edge of the blade that is offset with respect to the blade so that most of the bead is on the side of the blade that does not contact the material being moved.
